(19) United States
(12) Patent Application Publication
(10) Pub. No.: US 2024/0190036 A1
(43) Pub. Date: Jun. 13, 2024

(54) BINDER COMPOSITION AND METHOD FOR PRODUCING A WOOD MATERIAL, AND WOOD MATERIAL

(71) Applicant: SWISS KRONO TEC AG, Luzern (CH)

(72) Inventor: Norbert Kalwa, Horn - Bad Meinberg (DE)

(73) Assignee: SWISS KRONO TEC AG, Luzern (CH)

(21) Appl. No.: 18/286,891

(22) PCT Filed: Apr. 13, 2022
(86) PCT No.: PCT/EP2022/059876

§ 371 Date: Oct. 13, 2023

(30) Foreign Application Priority Data
Apr. 15, 2021 (EP) 21168616.7

(51) Int. Cl. B27N 3/00; B27N 3/02; C08G 18/08; C08G 18/16; C08G 18/18; C08G 18/76; C09J 5/00; C09J 175/04

(52) U.S. Cl. CPC B27N 3/002; B27N 3/02; C08G 18/0866; C08G 18/168; C08G 18/1816; C08G 18/1875; C08G 18/7664; C09J 5/00; C09J 175/04

(57) ABSTRACT

A binder composition for manufacturing a wood-based material, in particular a board-shaped wood-based material, a method for manufacturing such a wood-based material, and such a wood-based material. In order to provide a binder composition and a method for manufacturing such a wood-based material as well as such a wood-based material, in which the speed of curing of isocyanate binders can be controlled in a targeted manner and, in particular, accelerated, whereby the curing temperature can be lowered on the one hand and, on the other hand, can be kept within a predetermined temperature interval, so that a start of curing can be controlled whereby a safe, fast and cost-effective manufacturing process is made possible without a reduction in product quality, it is provided that the binder composition according to the invention for manufacturing a wood-based material has an organic phase having at least one isocyanate binder, an aqueous phase and also a phase transfer catalyst for accelerating the curing of the isocyanate binder.

### BACKGROUND OF THE INVENTION

The invention relates to a binder composition for manufacturing a wood-based material, in particular a board-shaped wood-based material, a method for manufacturing such a wood-based material, and such a wood-based material.

A wide variety of binder compositions, especially glues, are used in the manufacture of wood-based materials (HWS). Depending on the application, different binder compositions are favored or are particularly suitable. Binder compositions based on urea/formaldehyde have proved particularly suitable for wood-based boards that are later to be used in furniture manufacture or interior finishing. They are available in large quantities and boards manufactured with them meet the normative requirements placed on such boards. In addition, these boards are usually coated and sealed with edges on the narrow surfaces, so that the effects of moisture are almost certainly prevented here.

For applications in which elevated humidity levels or moisture regurgitation from adjacent building components is to be expected, such as flooring, urea-formaldehyde glues, possibly reinforced with melamine, are usually used, with the increased requirements being taken into account by an increased quantity of the binder compositions.

For wood-based boards used in areas with high humidity or in direct contact with water, urea-formaldehyde glues reinforced with melamine resin, phenolic resins or polymeric diphenylmethane diisocyanate (PMDI) have proven suitable. With these boards, static stresses are often added to the hygric stress. This is taken into account in the standards applicable to the products by testing swelling and flexural strength. Plywoods, chip boards and OSB (oriented strand boards) in particular are used for the various applications. These boards are preferably used in the construction sector for structural applications, in the automotive sector and as laying boards.

Although all binders that are not hydrolyzed by moisture or water can generally be used for the wood-based materials described above, polymeric diphenylmethane diisocyanate in particular has proven to be especially suitable for OSB. The reasons for this are the good water resistance of the binder composition and the absence of formaldehyde. This is particularly important because OSB is normally used uncoated and also in substantial square meter quantities related to room volume. If boards with glues containing formaldehyde are used, this combination can lead to problems despite the limit value observed with regard to formaldehyde emission.

However, the polymeric diphenylmethane diisocyanate has a serious disadvantage compared with the other binders, since its reactivity can hardly be controlled by the use of hardeners. This is particularly disadvantageous for thicker wood-based boards. Whereas with other binder or glue systems, significant manufacturing increases can be achieved by using different amounts of at least one hardener in the top and middle layers, this is not possible with polymeric diphenylmethane diisocyanate.

In addition, a temperature of about 100° C. is required for curing the polymeric diphenylmethane diisocyanate, so that in the case of thick wood-based materials, curing only occurs in the center of the wood-based material when this temperature is also reached there. Thus, a significant disadvantage here is that there is no effective control option for different board thicknesses, as well as a long processing time at high temperature is necessary due to slow curing inside the wood-based material.

Although it is known that polymeric diphenylmethane diisocyanate or isocyanate can generally be accelerated in their curing with polyols or also with amines, the reaction then already takes place at room temperature, which in the manufacturing of wood-based materials leads to systems that can no longer be controlled or at least to precuring and thus to increased glue use. This leads to an increase in manufacturing costs and at the same time to a reduction in product quality. In addition, this type of curing is very disadvantageous during plant shutdowns, since the entire quantity of glued strands from gluing to the press must then be discarded.

From DE 10 2007 062 316 A1, an anhydrous composition having isocyanate groups is already known as an alternative for moisture-curing systems with an NCO component, wherein the disclosed composition is to be cured without a component reactive towards isocyanate. In this regard, the composition has an “NCO prepolymer” which is produced by the reaction of an ester polyol with an isocyanate. In addition, the composition has at least one quaternary ammonium salt as a catalyst and about an equal amount of at least one compound bearing epoxide groups as a co-catalyst.

WO 00/46306 A1 describes a system for accelerating the curing of urea-formaldehyde glues. There, methylene di(phenyl isocyanate) (MDI) is mixed with a catalyst in amounts up to 1.9 wt % to the glue to achieve acceleration of curing. The catalysts are a variety of compounds based on tin salts and/or amines. These systems are offered under the trade name DABCO with various number additives.

### SUMMARY OF THE INVENTION

The invention is based on the technical object of providing a binder composition for manufacturing a wood-based material, in particular a board-shaped wood-based material, a method for manufacturing such a wood-based material, and such a wood-based material, in which the rate of curing of isocyanate binders can be controlled in a targeted manner and in particular accelerated wherein the curing temperature can be lowered on the one hand and kept within a predetermined temperature interval on the other hand, so that a beginning of curing can be controlled, thereby enabling a safe, fast and cost-effective manufacturing process without a reduction in product quality.

The binder composition according to the invention for the manufacturing of a wood-based material, in particular a board-shaped wood-based material, comprises an organic phase having at least one isocyanate binder, an aqueous phase and also a phase transfer catalyst for accelerating the curing of the isocyanate binder.

Furthermore, the invention relates to a method for manufacturing a wood-based material, in particular a board-shaped wood-based material, comprising at least the steps of manufacturing and/or providing a fiber and/or chip material, subsequently adding a binder composition, in particular a binder composition according to the invention, to the chip material, the binder composition having an organic phase comprising at least one isocyanate binder and a second, aqueous phase which is not completely miscible with the organic phase, and a phase transfer catalyst for accelerating the curing of the isocyanate binder, and finally the manufacturing of the wood-based material from the glued chip material, in particular manufacturing by pressing the glued chip material into a board-shaped wood-based material.

The wood-based material according to the invention, in particular manufactured by the method according to the invention, comprises at least one chip material and at least one cured binder composition, in particular a binder composition according to the invention, in at least one layer of the wood-based material, the binder composition containing at least one bound and/or cured isocyanate binder and a phase transfer catalyst for accelerating the curing of the binder.

Finally, the invention relates to the use of a binder composition according to the present invention with a phase transfer catalyst for the manufacturing of a wood-based material, in particular a board-shaped wood-based material.

The inventors have recognized that the use of a phase transfer catalyst in a binder composition of a wood-based material makes it possible to specifically control the reactivity and thereby both the speed of curing and the starting temperature of curing of an isocyanate binder. By means of the invention, it is also advantageously possible to accelerate the curing of the isocyanate binder, and in particular of PMDI, or to start the reaction at a lower temperature. In particular, the starting temperature can be adjusted so that the reaction does not already start at temperatures that are usually present after drying of the chip material during gluing, typically about 40° C.

Furthermore, the phase transfer catalyst is advantageously only required in small quantities so that it has no negative influence on the subsequent technological properties of the wood-based material and in particular of boards. This results in particular from the fact that a phase transfer catalyst is generally used in an amount one to two orders of magnitude lower than a hardener commonly used in the prior art. Furthermore, the use of the phase transfer catalyst makes it possible to manufacture a board-shaped woodbased material, in particular with a continuous pressing device, whereby this manufacturing can be carried out about 10% faster due to the phase transfer catalyst. Thus, the phase transfer catalyst enables fast, cost-effective and targeted manufacture of high-quality wood-based materials.

A binder composition is understood to mean a composition which is provided for the addition and gluing of chip material for a wood-based material, the binder composition preferably being formed in such a way that a wood-based material can be manufactured exclusively from the chip material and the binder composition. In principle, however, it is also possible to add further constituents, such as auxiliary materials and fillers, to the wood-based material. In this case, the binder composition can already be ready for use and/or be formed from a single component.

Alternatively, however, the binder composition can also be formed from several separately provided components, in particular from two components, which are only brought together and mixed before or during use. In particular, the organic phase can be one component and the aqueous phase the other component, with the phase transfer catalyst preferably being contained in the aqueous phase. In addition, however, it is also conceivable that the phase transfer catalyst is provided as a salt or dissolved as a further, in particular third, component and/or is added only for use. The phase transfer catalyst can also be produced in situ. This has the advantage that the counterion can be selected according to the application. The ready-to-use binder composition consisting of one or more then already mixed components is often also referred to as a glue or resin and, correspondingly, the application of the binder to the chip material is referred to as gluing.

Furthermore, it is particularly conceivable that the several components of the binder composition first come together on the surface of the material to be glued, in particular the chip material, wherein preferably a first component, in particular an aqueous phase, is first brought onto and/or into the chip material and subsequently the organic phase with the at least one isocyanate binder is added.

The wood-based material can in principle be any material, the majority of which, preferably at least 90% apart from the binder composition, is formed from wood, plant fibers and/or a material made therefrom by gluing a plurality of pieces of this material with a binder composition. Preferably, the material is at least a chip material. In principle, the wood-based material may have any shape, with board-shaped wood-based materials and, in particular, lignocellulosic and/or fibrous boards, chip boards and/or coarse chip boards being preferred.

The chip material can basically have any plant chips and/or fibers and is preferably formed essentially from plant chips. Particularly preferably, the chip material is manufactured from wood. Quite preferably, the chip material consists of long chips (strands) and/or coarse chips, in particular for manufacturing a coarse chipboard, also called OSB (oriented strand boards). The wood chips manufactured or provided for the manufacture of a coarse chipboard may have a length between 50 to 200 mm, preferably 70 to 180 mm, more preferably 90 to 150 mm; a width between 5 to 50 mm, preferably 10 to 30 mm, more preferably 15 to 20 mm; and a thickness between 0.1 and 2 mm, preferably between 0.3 and 1.5 mm, more preferably between 0.4 and 1 mm. For chip boards, the chip sizes for top and/or middle layers are preferably in the range of <1 mm to about 30 mm.

Although the shaping of the wood-based material can in principle be carried out in any way, it is preferably carried out as a continuous process, in particular by spreading the glued chip material onto a conveyor device, in particular onto a conveyor belt, and/or by pressing the glued chip material into the wood-based material. The forming of the wood-based material and in particular the pressing is preferably carried out under high pressure and/or at a high temperature, preferably of at least 150° C., more preferably between 170° C. and 220° C. and most preferably between 180° C. and 220° C.

In particular, the glued chip material for manufacturing a coarse chipboard is preferably spreaded in spreading devices alternately longitudinally and transversely to the direction of manufacturing, so that the chip material is arranged crosswise, especially preferably in at least three layers, in particular a lower surface layer, a middle layer and an upper surface layer. The direction of spreading of the lower and upper surface layers is preferably the same and/or differs from the direction of spreading of the middle layer. In general, the structure of the wood-based material, and in particular of a board-shaped wood-based material, is preferably multi-ply or multi-layered.

In principle, the wood-based material can be homogeneously structured in all spatial directions, although preferably a multi-ply or multi-layered structure is carried out and particularly preferably in differing layers, very preferably along a spatial direction and particularly preferably with respect to the thickness of the wood-based material. In this context, the individual layers may differ from one another, in particular, in their thickness, their density, the orientation of the chip material, the composition of the chip material, the dimensions of the chip material, the proportion of the binder composition contained and/or the chemical composition of the binder composition.

The manufacturing of the chip material is preferably carried out by peeling off debarked round wood, preferably coniferous wood, in longitudinal direction and/or by rotating knives. Furthermore, the chip material manufactured is preferably dried before the addition of the binder, in particular to reduce the natural moisture of the chip material at high temperatures. Particularly preferably, the moisture content of the chip material after drying is below 10% and very particularly preferably below 7% in order to avoid splitting during subsequent pressing and/or to avoid strong vapor formation during pressing.

The addition of the binder composition to the chip material is preferably a gluing of at least part and preferably all of the chip material as the starting material for the wood-based material. Furthermore, the binder composition is preferably applied to the chip material in a finely distributed manner. Alternatively, it is conceivable that first a first component of the binder composition is applied or the chip material is soaked therein and then only the second component is applied. The amount of the binder composition, in particular in the case of the use of PMDI as binder, is preferably 1 to 10% by weight, more preferably 2 to 7% by weight, in particular 5% by weight, based on the total amount of the chip material.

In the wood-based material according to the invention, the binder composition is preferably completely cured after its manufacture, in which case, in particular, the isocyanate binder is preferably reacted with the water of the aqueous phase to form carbamic acids and/or further to form the corresponding amines and/or polyureas. In this context, the cured binder composition preferably consists essentially of polyureas, the phase transfer catalyst and/or further constituents of the organic and/or aqueous phase.

According to the invention, the binder composition has at least one isocyanate binder. In principle, the binder composition can have only one binder or a mixture of several binders, in particular depending on the desired properties of the manufactured wood-based material, whereby the other binders can also be isocyanate binders or any other binders. The proportion of all binders, in particular of the isocyanate binder, in the binder composition is preferably between 60% and 99% by weight, particularly preferably at least 70% by weight and very particularly preferably at least 85% by weight. The proportion of water or the proportion of the aqueous phase in the binder composition is preferably between o and 15% by weight, particularly preferably between 0.01 and 10% by weight and most preferably between 0.5 and 8% by weight.

According to the invention, the binder composition has at least one, preferably exactly one phase transfer catalyst, although it is also conceivable in principle to use several chemically different phase transfer catalysts simultaneously. The phase transfer catalyst according to the invention basically allows components of the aqueous phase, in particular water itself, to enter the non-aqueous or organic phase, in particular to the isocyanate binder, in which case the water is very particularly preferably the reactant for curing the binder. Accordingly, the phase transfer catalyst preferably transfers water from the aqueous phase to the organic phase, where a reaction with the isocyanate can occur and subsequently the phase transfer catalyst is released again.

Thus, the phase transfer catalyst accelerates the reaction of curing the isocyanate binder, but is not itself directly involved in the reaction. In particular, the phase transfer catalyst is preferably selected so that it is not involved in activation of the isocyanate group of the binder. The phase transfer catalyst leads to a lower necessary reaction temperature and/or to a shortened reaction time and also enables good controllability of the reaction kinetics. There is preferably a linear relationship between the gelation time or the duration of curing and the amount of phase transfer catalyst used.

The aqueous and the organic phases are in principle not completely miscible, preferably only slightly miscible and especially preferably—optionally down to minute amounts—not miscible. Accordingly, at least at the time of addition of the binder composition to a chip material, the binder composition is preferably a multiphase mixture that can be stable over the long term as well as segregate again over time.

A preferred embodiment of the binder composition according to the invention provides that the phase transfer catalyst has an onium ion. Particularly preferably, the phase transfer catalyst has a single onium ion, and most preferably, the phase transfer catalyst is an onium salt. In this context, the onium salt can be an inorganic salt as well as having organic residues or organic ions. In general, it is advantageous to use the phase transfer catalyst as a salt, the effect preferably being achieved by the cation. In this case, the cation is preferably singly charged. In principle, any anion can be used as the counterion, the anion preferably being an inorganic and/or a single-negative anion, particularly preferably a monatomic anion and most preferably a halide. In principle, however, the phase transfer catalyst can have any anion, for example nitrate, as a counterion. Counterions based on organic acids can also be used. Varying the counterion is one way of controlling the catalyst effect.

A particularly preferred embodiment of the binder composition according to the invention is one in which the phase transfer catalyst has an ammonium, phosphonium and/or sulfonium ion and, in particular, is formed by such a cation. Accordingly, the phase transfer catalyst is preferably a quaternary ammonium compound or else a corresponding phosphonium and/or sulfonium compound. Particularly preferably, the phase transfer catalyst is an ammonium, phosphonium and/or sulfonium salt.

In particular, an embodiment of the binder composition according to the invention with a triethylbenzylammonium salt, especially triethylbenzylammonium chloride, as phase transfer catalyst is preferred. In this context, the triethylbenzylammonium chloride (TEBA) is often also referred to as benzyltriethylammonium chloride. Alternatively, triethylenediamine (TEDA) or a salt, preferably an ammonium salt and in particular the ammonium chloride of TEDA can also be used as a phase transfer catalyst. In this context, TEDA is occasionally also referred to as DABCO, but this is not unambiguous, since numerous other substances and substance mixtures are also regularly referred to as DABCO, including compositions with catalysts based on tin salts and/or amines, for which DABCO is used as a trade name.

However, another, preferably organic, phase transfer catalyst can also be used. Very preferably, the phase transfer catalyst is a crown ether, in particular 12-crown-4, although any other crown ethers, for example 15-crown-5 or 18-crown-6, are also conceivable. Such a crown ether as phase transfer catalyst can in principle be used alternatively or additionally to another of the phase transfer catalysts, preferably an onium salt and in particular to TEDA.

According to an advantageous further development of the binder composition according to the invention, the binder composition is formaldehyde-free and/or does not release formaldehyde before, during or after curing, which makes it particularly suitable for indoor use.

Although any isocyanate binder may be included in the binder composition and preferably forms its primary binder, it is preferred that the isocyanate binder has polymeric diphenylmethane diisocyanate (PMDI) and in particular is polymeric diphenylmethane diisocyanate. Quite preferably, the diphenylmethane diisocyanate is the only isocyanate binder and, in particular, preferably generally the only binder in the binder composition. In principle, however, it is also possible to use, for example, toluene-2,4-diisocyanate (TDI), hexamethylene diisocyanate (HDI), methylene diphenyl diisocyanate (MDI), meta-tetramethyl xylylene diisocyanate (TMXDI), isophorone diisocyanate (IPDI) and/or 4,4′-diisocyanato dicyclo hexyl methane (H12MDI) or of a further isocyanate are conceivable as isocyanate binders individually or in combination, in particular with polymeric diphenylmethane diisocyanate (PMDI).

In an advantageous embodiment of the binder composition according to the invention, the proportion of the phase transfer catalyst is 0.01% to 5% by weight, preferably 0.02% to 2% by weight, particularly preferably 0.05% to 1.0% by weight and most preferably 0.1% to 0.5% by weight, based on the mass of the isocyanate binder. Here, the amount of phase transfer catalyst added to the binder composition is essential for controlling the reaction rate of the isocyanate binder and/or the curing of the binder. Alternatively or additionally, control can be carried out by adjusting or adapting the temperature.

A preferred further development of the method according to the invention for manufacturing a wood-based material provides that the addition of the binder composition is carried out in the form of an addition of two separate components of the binder composition to the chip material, one component preferably being the organic phase comprising the isocyanate binder and/or the other component preferably being the aqueous phase, in which the phase transfer catalyst is particularly preferably contained, in particular dissolved. Preferably, the two components of the binder composition meet on the surface of the chip material. In addition or alternatively, one of the components, in particular the aqueous phase, can also first be added to the chip material, in particular being applied uniformly to its surface, and then the second component, in particular the isocyanate binder or the organic phase, is subsequently added. This is preferably carried out in a glue drum or coil. Alternatively, it is also possible for the binder composition consisting of at least two and preferably exactly two components to be combined only immediately before addition to the chip material, preferably by mixing the organic phase and the aqueous phase, in particular with the phase transfer catalyst, into one another. This can be carried out before the glue drum or coil with the aid of a static mixer, for example.

According to the invention, the wood-based material has at least one layer, whereby a structure in several layers and especially in at least three layers, in particular a lower surface layer, a middle layer and an upper surface layer, is advantageous. Furthermore, preferably at least one of the layers, preferably the middle layer, has a binder composition with a phase transfer catalyst and at least one further layer, preferably the lower or the upper surface layer and particularly preferably the lower and the upper surface layer, has a binder composition without a phase transfer catalyst. In general, it is preferred that only a single layer, in particular a middle layer, or only all layers arranged inside the wood-based material and/or not forming a surface layer have a binder composition with a phase transfer catalyst.

Finally, an advantageous embodiment of the wood-based material according to the invention has a structure with at least three layers, in particular at least one lower surface layer, a middle layer and an upper surface layer, at least two of the layers, preferably including the middle layer, and particularly preferably all the layers, having a binder composition with a phase transfer catalyst, the proportion of the phase transfer catalyst in the middle layer being higher than in the surface layers. A different proportion of the phase transfer catalyst can be used to take account of the different rates of heat input, in particular during pressing of wood-based boards, and thus to ensure particularly uniform curing of the binder over the entire thickness of the wood-based material. Particularly preferably, the proportion of phase transfer catalyst increases from the surface layers toward the layers in the middle of the wood-based material. Preferably, the proportion of phase transfer catalyst of a middle layer is between 5% and 500%, more preferably between 10% and 200%, and most preferably between 20% and 100% higher than the proportion of phase transfer catalyst in a surface layer, in particular in both surface layers.

### DETAILED DESCRIPTION

The invention is explained in more detail below on the basis of several comparative tests and in the form of exemplary embodiments.

### Exemplary Embodiment 1

In a test tube, 20 ml of water containing an amount of a phase transfer catalyst specified in Table 1 is overlaid with the same amount of polymeric diphenylmethane diisocyanate (PMDI), an isocyanate binder, as the organic phase. Triethylbenzylammonium chloride (TEBA) and diazabicyclooctane (DABCO), especially used as diammonium salt with HCl, are tested as phase transfer catalyst. The test tube is then transferred to a water bath, which is brought to the temperature indicated in column 4 of Table 1 with the aid of a heating plate located underneath. Using a glass rod, the gelation time is determined at regular intervals by immersion in the PMDI. The gelation time was considered to be reached when the PMDI did not have a liquid but a solid, crumbly consistency when immersed.

TABLE 1
Comparative tests without phase transfer catalyst and
with triethylbenzylammonium chloride (TEBA) and diazabicyclooctane
(DABCO) (DABCO as ammonium salt with HCl)

| | | Amount of catalyst in | Temperature | Gel time |
|---|---|---|---|---|
| No. | Catalyst | % related to PMDI | in ° C. | in min |
| 1 | Zero sample | 0 | 40 | 41.0 |
| 2 | DABCO | 0.1 | 40 | 37.0 |
| 3 | TEBA | 0.1 | 40 | 39.0 |
| 4 | Zero sample | 0 | 80 | 12.44 |
| 5 | DABCO | 0.1 | 80 | 8.45 |
| 6 | TEBA | 0.1 | 80 | 11.02 |
| 7 | DABCO/TEBA | 0.1 | 80 | 8.26 |
| | 1:1 | | | |
| 8 | TEBA | 0.2 | 80 | 8.21 |
| 9 | DABCO/TEBA | 0.2 | 80 | 8.59 |
| | 1:1 | | | |
| 10 | Zero sample | 0 | 100 | 5.57 |
| 11 | TEBA | 0.1 | 100 | 4.30 |
| 12 | DABCO | 0.1 | 100 | 5.01 |
| 13 | DABCO/TEBA | 0.1 | 100 | 5.28 |
| 14 | TEBA | 0.2 | 100 | 5.58 |
| 15 | DABCO | 0.2 | 100 | 5.41 |
| 16 | DABCO/TEBA | 0.2 | 100 | 5.33 |
| | 1:1 | | | |
| 17 | TEBA | 0.5 | 80 | 4.39 |
| 18 | DABCO | 0.5 | 80 | 4.22 |
| 19 | TEBA | 0.5 | 100 | 5.19 |
| 20 | DABCO | 0.5 | 100 | 3.23 |

As can be seen, the addition of the phase transfer catalyst significantly reduces the gelation time. There is approximately a linear relationship between gel time and amount of phase transfer catalyst. Mixing catalysts does not provide significant advantages over single catalysts. By variable addition of the catalyst, on the other hand, the curing of the PMDI can be controlled.

### Exemplary Embodiment 2

Beech yokes are placed for one hour in a 0.5 wt % solution of triethylbenzylammonium chloride (TEBA) in water with the side that will later be used for gluing. They are then fixed on a second yoke, to which diphenylmethane diisocyanate (PMDI) has been applied in an amount of about 100 g/m², using a screw and a torque wrench with identical force. Comparison samples without TEBA, which have merely been placed in water, are also tested. The samples are then stored in a drying cabinet at 80° C. Samples and comparison samples are taken after 10, 20, 30 and 40 minutes respectively. These specimens are quickly cooled to room temperature and then the transverse tensile strength is determined using a testing machine.

TABLE 2
Transverse tensile strength test with
and without phase transfer catalyst

| | Zero sample | TEBA |
|---|---|---|
| | Transverse tension in | Transverse tension in |
| Curing time in min | N/mm² | N/mm² |
| 10 | 0 | 0.08 |
| 20 | 0.08 | 0.16 |
| 30 | 0.26 | 0.41 |
| 40 | 0.52 | 0.54 |

As can be seen from Table 2, the variant with the phase transfer catalyst reacts earlier than the variant without catalyst. At a curing time of 40 minutes, the effect is lost.

### Exemplary Embodiment 3

In the manufacture of an OSB (Oriented Strand Board), triethylbenzylammonium chloride (TEBA) is added as a catalyst to a binder composition containing the isocyanate binder polymer diphenylmethane diisocyanate (PMDI) in an amount of 0.5% by weight based on the mass of the PMDI. The binder composition is intended for gluing the chip material of a middle layer of the OSB. The catalyst is added as an aqueous solution via a static mixer immediately before gluing of the chip material, the volume ratio of the organic phase to the added aqueous phase being 1:0.4.

No TEBA was added as a phase transfer catalyst to the PMDI-containing organic phase of the binder composition intended for gluing the chip material of the surface layers. Subsequently, the respective chip material is sprayed with the two binder compositions in the coil and fed to a Conti press after spreading for an 18 mm board. In this process, the speed was gradually increased by 10% compared with manufacturing without catalyst. No splitting or other problems were observed during manufacturing. When testing the technological values (transverse tensile strength, swelling), no differences were found compared with manufacturing at standard speed.

### Exemplary Embodiment 4

The phase transfer catalysts are used in the top and middle layers of wood-based boards when PMDI is used as a glue. The dosage in the middle layer is chosen higher, because the heat of the press reaches the middle layer with a delay. In this case, the catalyst is added as an aqueous solution, with a 0.2 wt % added to the middle layer and a 0.5 wt % added to the surface layers. Otherwise, the manufacture of the wood-based boards is carried out as indicated in exemplary embodiment 3.

1. A binder composition for manufacturing of a wood-based material, comprising
an organic phase having at least one isocyanate binder,
an aqueous phase and
a phase transfer catalyst to accelerate the curing of the isocyanate binder.

2. The binder composition for manufacturing a wood-based material according to claim 1, wherein the aqueous phase is immiscible with the organic phase and is provided as reactant for curing the isocyanate binder.

3. The binder composition for manufacturing a wood-based material according to claim 1, wherein the phase transfer catalyst has an onium ion.

4. The binder composition for manufacturing a wood-based material according to claim 1, wherein the phase transfer catalyst has an ammonium, phosphonium and/or sulfonium ion.

5. The binder composition for manufacturing a wood-based material according to claim 1, wherein the phase transfer catalyst is triethylbenzylammonium chloride.

6. The binder composition for manufacturing a wood-based material according to claim 1, wherein the phase transfer catalyst is a crown ether.

7. The binder composition for manufacturing a wood-based material according to claim 1, wherein the binder composition is formaldehyde-free and/or does not release formaldehyde.

8. The binder composition for manufacturing a wood-based material according to claim 1, wherein the isocyanate binder is polymeric diphenylmethane diisocyanate.

9. The binder composition for manufacturing a wood-based material according to claim 1, wherein a proportion of the phase transfer catalyst is 0.1% to 0.5% based on the mass of the isocyanate binder.

10. A method for manufacturing a wood-based material, comprising the steps:
manufacturing and/or providing a chip material,
adding a binder composition to the chip material, the binder composition having an organic phase comprising at least one isocyanate binder and a second aqueous phase immiscible with the organic phase, and a phase transfer catalyst for accelerating curing of the isocyanate binder; and
forming the wood-based material from the glued chip material.

11. The method for manufacturing a wood-based material according to claim 10, wherein the addition of the binder composition to the chip material is carried out in the form of an addition of two separate components of the binder composition, one component being the organic phase comprising the isocyanate binder and the other component being the aqueous phase in which the phase transfer catalyst is dissolved.

12. The method for manufacturing a wood-based material according to claim 10, wherein the binder composition consisting of two components is formed only immediately before addition to the chip material by mixing the organic phase and the aqueous phase with the phase transfer catalyst into one another.

13. A wood-based material manufactured by a method according to claim 10, comprising at least one chip material and at least one cured binder composition in at least one layer of the wood-based material wherein the binder composition has at least one cured isocyanate binder and a phase transfer catalyst for accelerating the curing of the binder.

14. The wood-based material according to claim 13, further comprising a structure in at least three layers, wherein at least one of the layers has a binder composition with a phase transfer catalyst and at least one further layer has a binder composition without phase transfer catalyst.

15. The wood-based material according to claim 13, further comprising a structure comprising at least a lower surface layer, a middle layer and an upper surface layer, all layers having a binder composition comprising a phase transfer catalyst, the amount of phase transfer catalyst being higher in the middle layer than in the surface layers.

16. The binder composition according to claim 6, wherein the crown ether is 12-crown-4.

17. The method according to claim 10, wherein the forming step comprises pressing the glued chip material into a board-shaped wood-based material.

18. The wood-based material according to claim 14, wherein the at least three layers comprise a lower surface layer, a middle layer and an upper surface layer.

19. The wood-based material according to claim 18, wherein the middle layer has the binder composition with the phase transfer catalyst.
